(19) United States
(12) Patent Application Publication
(10) Pub. No.: US 2006/0129941 A1
(43) Pub. Date: Jun. 15, 2006

(54) System with macrocommands

(76) Inventor: Gerrit Hollemans, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,025

(22) PCT Filed: Dec. 15, 2003
(86) PCT No.: PCT/IB03/06074

§ 371 Date: Jun. 15, 2005

(30) Foreign Application Priority Data
Dec. 20, 2002 (EP) 020805230

(51) Int. Cl. G06F 3/00; H04N 7/14

(52) U.S. Cl. 715/740; 708/146; 708/142; 348/14.05

(57) ABSTRACT

In a home system, sequences of received user commands are stored. A matching unit determines whether matching sequences of commands are received repeatedly, or whether a sequence accomplishes an opposite effect. If so, the system adds a new macrocommand to a user interface. The new macrocommand becomes user-selectable so that, in response to user selection of the further command, the user interface sends control signals for executing a series of commands corresponding to commands of the first sequence. The system also adds a further macrocommand to the user interface which enables the user to accomplish the opposite effect of the first macrocommand.

The invention relates to a system which is capable of executing macrocommands, and in particular to a system comprising a user-controllable device and a user interface arranged to receive user-selectable commands and to send control signals to the device for executing the commands, at least two of said user-selectable commands having an opposite effect.

The invention further relates to a remote control unit and to a controllable device for use in the above system.

PCT patent application WO 98/59284 describes a method and apparatus for creating macrocommands for a home network. The network receives commands, for example, from inputs in an HTML page. Initially, each input, when activated, causes execution of a user command. A macrocommand involves execution of a series of such user commands upon activation of a single, newly defined input for that macrocommand.

A home network with home devices as defined in WO 98/59284 (WO 98/59284 excludes general-purpose computers from the definition of home devices) interconnects electronic devices that are typically found in the home. Such a network is operated by consumers who are usually not skilled technicians. In practice, it has been found that such unskilled users do not write their own new macros.

WO 98/59284 describes various ways of assisting the user in generating macros. For example, the use of a preset macro is described for presetting the parameters of the system to some preference. A preset macro is generated by reading the values of parameters of the system when the system is in the preferred state and copying these values into commands in the macro for setting these parameters. In another example, a macro is generated when the user instructs the system to record a macro. The system records the commands given by the user after this instruction into the macro. In another example, macros are prepared externally, for example, by the manufacturer of a device in the system.

It is, inter alia, an object of the invention to provide a system allowing unskilled users to profit from macrodefinition.

The invention provides a system comprising
a user-controllable device;
a user interface arranged to receive user-selectable commands and to send control signals to the device for executing the commands, at least two of said user-selectable commands having an opposite effect;
a memory unit arranged to record a first sequence of received commands;
a matching unit for determining whether a second sequence of commands received subsequent to said first sequence matches or counter-matches said first sequence;
the system being arranged to add a further command and a further opposite command to the user interface in response to detection that said second sequence matches or counter-matches said first sequence, the further command and the further opposite command becoming user-selectable so that, in response to user selection of the further command, the user interface sends control signals for executing a series of commands corresponding to commands of the first sequence, and in response to user selection of the further opposite command, the user interface sends control signals for executing a series of commands corresponding in an opposite way to commands of the first sequence.

Examples of opposite commands are volume up/down, brightness higher/lower, channel up/down, etc. The system thus takes the initiative to select the content of a macro. It obtains the contents of the macro by copying sequences of commands that the user has used to control the system. Matching sequences are inserted in system-generated macros with mutually opposite effect. Sequences of commands are said to match when they have the same lasting effect on the system after the completion of each sequence. That is, sequences that differ only in commands that have no lasting effect, such as later corrected erroneous commands or commands for temporary lookup of information, are still said to match. Such inconsistent commands need not be incorporated in the resulting series of commands of the macro. Sequences of commands are said to counter-match when they have an opposite lasting effect on the system after the completion of each sequence.

Various situations may trigger the system to generate the macros. For example, if the user successively operates the channel-up button a specific number of times, and after a while successively operates the channel-down button the same number of times, the system may react by generating a macro both for shifting the selected channel upward and downward that specific number of times. Alternatively, the system waits for at least a second occurrence of this channel up/down loop. A user who is repeatedly zapping between two non-adjacent channels is thus provided with macrocommands for skipping the intermediate channels and immediately selecting the desired channel.

In another situation, which may trigger the generation of opposite macros, the user performs substantially the same sequence of commands at least two times. The system then generates a macro corresponding to this sequence, and an opposite macro which accomplishes the opposite effect of the sequence of commands, for example, by copying the sequence of commands and replacing each command, if possible, by its opposite command.

In an embodiment of the system according to the invention, the matching unit is capable of recognizing in the first sequence an iteration of a basic command, the system being arranged to determine an opposite basic command which has the opposite effect of said basic command, and to include an iteration of said opposite basic command in said further opposite command. It occurs very often that the user operates the same button iteratively, for example, to substantially increase a certain parameter such as sound volume or picture brightness, or zap through a number of channels. Typically, these types of commands have a counter-command for accomplishing the opposite effect, i.e. decreasing the sound volume or picture brightness, or zapping in the reverse direction. The invention is particularly useful for generating opposite macrocommands for such iterative parameter adjustments.

In an embodiment of the system according to the invention, user selection of the further command involves at least selection of said basic command and user selection of the further opposite command involves at least selection of said opposite basic command. Particularly if the sequence consists only of an iteration of a certain basic command, e.g. channel up, the invoking of the resultant macro advantageously involves that basic command itself. It saves additional macrobuttons on the (remote) control unit, and it is easier for the user to remember how to invoke the macro. Invoking of the opposite macrocommand then involves the basic opposite command. This can be achieved in various ways.

In one embodiment, the control unit comprises a single macrobutton, which, for example, has to be pressed before or after the button corresponding to the basic command, for confirming execution of the macro rather than the basic command itself. For example, pressing the ‘channel up’ button followed by pressing the macrobutton causes the system to execute an earlier defined macro involving an iteration of the ‘channel up’ command. Pressing the ‘channel down’ button followed by pressing the macrobutton causes the system to execute the opposite macro involving an iteration of the ‘channel down’ command.

In an alternative embodiment, the macros can be selected by prolonged operation of the buttons corresponding to the related basic commands. For example, a short press of the ‘channel up’ button causes the next channel preset to be selected, whereas a prolonged press of the button causes zapping through the channels by as many steps as included in the macro.

In yet another embodiment, the macros can be selected by simply operating the buttons corresponding to the related basic commands, i.e. the macrocommand temporarily replaces the normal command. The normal command may be selected by prolonged or iterated operation of the same button. The system may warn the user by generating feedback, e.g. on the television screen, that the normal command now requires a different operation. The normal command may, for example, be restored after a predetermined period of time, after a deliberate selection of the basic command (e.g. by prolonged operation), or, in case of channel selection, by explicitly entering the desired channel preset number.

It is not necessary that such a macro includes only one iterated command. It may very well be that the user, while repeatedly switching between two non-adjacent channels, also systematically adjusts the sound volume as well, e.g. by pressing the volume up/down buttons three times, respectively. Dependent on what command occurs first in the sequence, the resultant macro may be assigned to the button related to that particular command, i.e. in the example given, the macro consisting of an iteration of channel up/down commands and an iteration of volume up/down commands will be assigned to the channel up/down buttons, respectively.

The invention can be implemented in an independent remote control unit, comprising all the means for generating the macros, and transmitting the macrocommands to a controlled device. Alternatively, a conventional remote control unit is used, but its commands are interpreted according to the invention, i.e. sequences of commands are detected, opposite commands are determined and macros are generated within the controlled apparatus. It is also possible that the inventive means are spread on the remote control unit and the controlled device, for example, the macros may be generated in the device, but additional signals may be transmitted to the controlled device in order to give feedback via the display or speakers of the controlled device.

These and other advantageous aspects of the system, method and apparatus according to the invention will be described in more detail, using the following Figures.

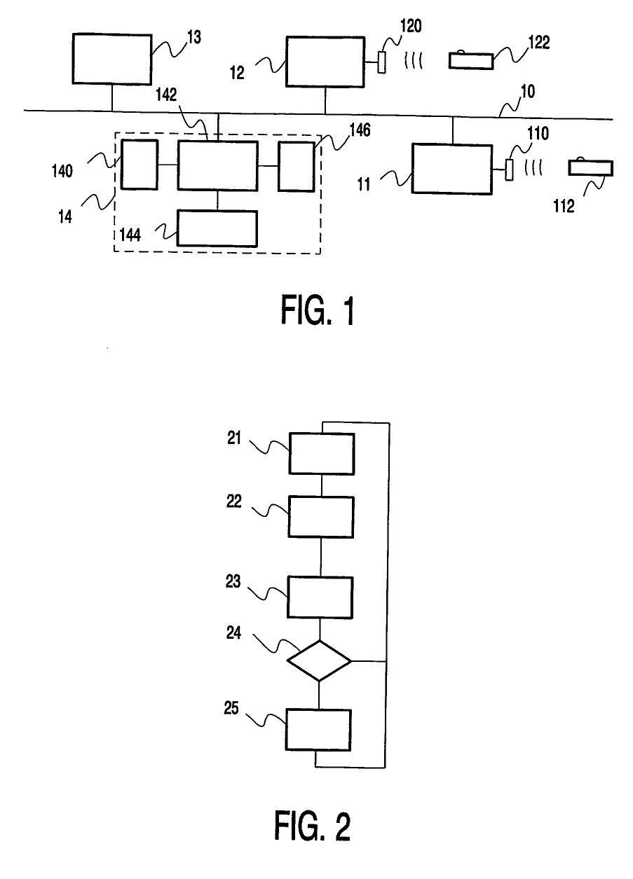

FIG. 1 shows a system of home apparatuses

FIG. 2 shows a flowchart for defining a macroinstruction

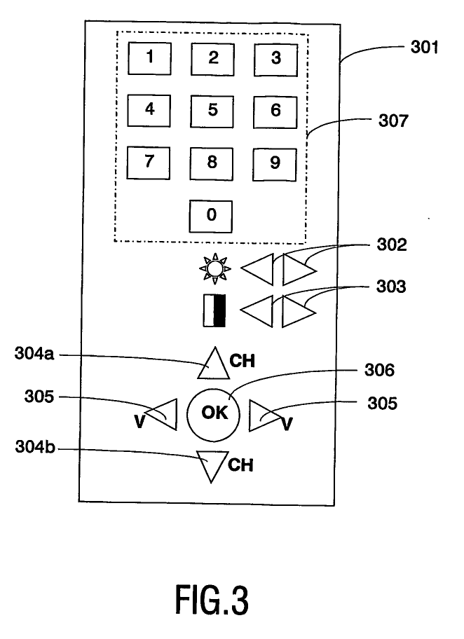

FIG. 3 shows a remote control unit according to the invention

FIG. 1 shows a system of home apparatuses 11, 12, 13, 14 interconnected by a bus 10. Although a linear bus structure is shown, any bus structure, such as a tree structure in the case of a P1394 bus, may be used. By way of example, two of the apparatuses 11, 12 are shown to have an input 110, 120 for remote control signals for remote control units 112, 122. A third apparatus 14 is shown in more detail. A control unit 142 comprising, for example, a microprocessor, a memory 140, a user interface 144 and a display unit 146 are shown.

In operation, a user may use the system, for example, to perform operations like playing or recording video or audio information in the home. For example, one apparatus 11 may be a video source and/or recording device, such as a video recorder, a DVD player, a magnetic disc unit or the like, and another apparatus 14 may be a television set. In this case, the user instructs the video source 11 to retrieve the video information and send it to the television set 14 via bus 10. The user instructs television set 14 to receive the video information from the bus 10, to decode it and to show it on display unit 146. In another example, the user instructs the television set 14 to output video information via the bus 10 to a recording device 12 and the user instructs recording device to receive the video information and to record it.

Yet another one of the apparatuses 12 may be a set-top box 12 for receiving video signals from a cable system, or an Internet interface unit 13, etc. These may also serve as image sources, video sources, audio sources or data sources of information that may be displayed, output or recorded in the system, or as receivers for such information.

All of these such operations are controlled in more or less detail by the user. Some operations are started by a single user command, but often the user will have to enter a series of two or more commands to cause the system to execute the operation, indicating, for example, a data source and a data destination, as well as what has to be done with the data. In one mode, the user uses a central user interface 144 for entering all of these commands. In another mode, the user uses one or more remote control units 112, 122 to enter the commands. Entry of commands may be an interactive process, in which a menu or a dialog box (e.g. an image showing various buttons to select commands) is displayed, for example, on display unit 146, in order to show the user which commands can be entered and how.

The system enables the user to define new commands, so-called “macrocommands” which are composed of two or more commands that can be given to the system. Once a new macrocommand has been defined, the system enables the user to select this new command, for example, by adding the new command to a menu, adding a “button” for the command to a dialog box or associating the command with a button, or a combination of buttons on a remote control unit (generally, this will be called adding the command to the system). When the user selects the command, the system executes the commands of which it is composed in response.

For example, the macrocommand may instruct the system to record information that is currently displayed on a specified display device on a specified recording device.

In an embodiment, selection of the macrocommand occurs when the user enters the initial command of the commands of which the macrocommand is composed, followed within a predetermined time by entering a predetermined generic “execute macrocommand”. If the user starts entering the initial command of the commands of which the macro is composed and then remembers that the macro has been defined, he can select the macro by subsequently entering such a generic macrocommand. If a part of the macro has been executed manually, the system should only play the remaining part of the macro (retrieving from memory the already past sequence).

In order to help the user define macrocommands, the system takes the initiative to suggest new macrocommands. The system monitors commands given by the user and when the system detects that the user has given two or more series of commands which match with each other, the system constructs a sequence of commands for the matching part of the series of commands and asks the user whether a macrocommand should be added for executing this sequence of commands.

In the case that the macrocommand includes commands which have a counter-command having an opposite effect, the system is arranged to construct two macros, one having the same effect as the detected sequence of commands, and one having the opposite effect. This may also be triggered in the event that the user has entered two sequences of commands, the second having an effect which is opposite to the effect brought about by the first sequence. This may be achieved by copying the first macro and replacing all commands, when possible, by their opposite commands.

FIG. 2 shows a flowchart of steps for adding macrocommands in this way. In the system of FIG. 1, these steps are executed, for example, by control unit 142. In a first step 21, the control unit 142 monitors commands given by the user and detects whether a new command has been entered that is the end of a potential macrosequence. The control unit 142 identifies a series of commands as a potential macrosequence, for example, if the successive commands in the series are given less than a predetermined time (for example, 10 seconds) after one another. The end command of such a potential macrosequence is not followed by another command within a predetermined time (for example, the same predetermined time as used to identify the potential macrosequence, of a longer time, for example, 30 seconds).

In a second step 22, control unit 142 stores the potential macrosequence in memory 140. If necessary, space for storing is created in a memory, for example, by discarding one or more least recently used potential macrosequences. In a third step 23, control unit 142 searches through memory 140 for a previously stored potential macrosequence that matches or counter-matches the newly stored potential macrosequence with a matching part that does not correspond to the sequence of commands of an existing macrocommand. In a fourth step 24, control unit 142 branches back to the first step if it finds no such matching potential macrosequence in memory 140.

If control unit 142 does find such a potential macrosequence, it executes a fifth step 25, suggesting to the user to define a new macrocommand for the potential macrosequence and a further macrocommand with an opposite effect, for example by displaying a message on display unit 146 that a potential new macrosequence has been found, together with a listing of the effects of the commands of the potential new macrosequence. Alternatively, confirmation of the user is not awaited and the macros are generated anyway, preferably after showing a notification to the user. Subsequently, the control unit resumes action from the first step 21.

If the user enters a command to approve addition of the new macrocommand, or if the approval is not required, control unit 142 adds the command to the system, for example, so that upon entering a command from user interface 144, the commands from the potential new macrosequence, or the matching part of the sequence are generated. However, without deviating from the invention, other interfaces 112, 122 may be used to trigger execution of the macrocommands. The control unit 142 may select automatically which interface may be used, for example, implementing the macrocommand on one or all of the interfaces from which commands were received in the potential new macrosequence. Alternatively, the control unit 142 may ask the user to indicate to which interface the new macrocommand should be attached.

Preferably, the system has a command that allows the user to enable and disable suggestion of the new macrocommand in the fifth step (for example, by selecting a “disable/enable macro suggestion” button in a dialog box). This allows the user to restrict macro suggestions to times when they are desired.

The control unit 142 may use various types of criteria in the third step 23 to determine whether potential macrosequences match each other. In one embodiment, the control unit simply detects a match if two sequences consist of identical commands in the same order. In another embodiment, a match is detected if in addition to the identical commands the sequences contain additional commands that do not affect the end result of the sequences, and/or if the commands occur in different order in the two sequences, as long as this does not affect the end result. A similar approach can be used for detecting a counter-match between two command sequences.

In a further embodiment of the matching in the third step, control unit 142 generalizes the parameters of the commands in the sequences. That is, if commands with the same function in respective ones of the sequences differ only in parameters (e.g. “output video to the bus” commands that differ only in the source apparatus of the video), control unit 142 treats them as potentially matching commands, with substitution of parameters, when two potential macrosequences are compared. The substitution relates two parameter values to each other, one from each of the matching sequences. When these parameter values are substituted for each other in accordance with this relation in all corresponding commands of the matching sequences, these sequence are said to match.

In the generated macrocommand, the parameter value may be included as a parameter of the macrocommand, to be entered by the user when he selects the macrocommand. As an alternative, the control unit 142 stores a state description of the system at the start of and/or during execution of each potential new macrosequence in memory 140, together with the macrosequence (the state description contains information about active data transport streams, channels to which the apparatuses are tuned, etc.). In this alternative, the control unit determines whether the substitution also relates parameters in the state of the system stored for the respective potential new macrosequences. If so, the control unit 142 includes in the newly generated macro a command for reading the relevant parameter from the state of the system.

Thus, for example, suppose that the two matching potential macrosequences are both sequences to record information on a disk unit. In this case, the control unit 142 will suggest a macro for storing information on the disk unit. However, suppose that one potential macrosequence commands that information from a web page received at an Internet interface is stored, and the other sequence commands that information from a television channel received at a tuner is stored. Suppose further that control unit 142 finds that a parameter of a state of the system indicates that before the start of the two sequences the source of information displayed on display unit 146 is the Internet interface and the tuner, respectively. Then control unit 146 will add a command to the macro to read the parameter of the state of the system during execution of the macro to determine the source of the information displayed on the display unit 146, and commands in the macro will use the resulting value of the parameter to indicate the source of the information that is stored on the disk unit.

In an embodiment of the first step 21, the control unit 142 restricts the potential macrosequences to sequences of coherent commands, wherein each command is said to be “connected” to another command in the sequence in the sense that the command affects or uses data that is affected or used by the other command in the sequence, and wherein all commands are connected to one another directly, or indirectly via other commands.

In an embodiment, control unit 142 includes only commands received via the control interface 144 in the potential macrosequences generated in the first step. In another embodiment, control unit 142 monitors the bus 10 to detect whether commands have been received at other interfaces, such as receivers 120, 110 for signals from remote control units 122, 112, or such as control buttons of apparatuses 11, 12, 13. In this embodiment, control unit 142 also incorporates the commands thus detected in the potential macrosequence, stores them in memory 140 and uses them in the third step 23 during matching.

FIG. 3 shows a remote control unit 301 according to the invention. It comprises various control buttons among which there are four pairs of control buttons for adjusting television parameters. Buttons 302 enable the user to adjust the picture brightness, buttons 303 enable the user to adjust the picture contrast, buttons 304a and 304b are used to zap upward and downward through TV channel presets, and buttons 305 enable the user to adjust the sound volume. Numeric buttons 307 are provided for explicit entering of numeric values, such as channel preset numbers. A confirmation button 306 serves various functions, for example, it enables the user to select a menu option, or confirm an operation. Only those buttons necessary for explaining the invention are shown, additional buttons for e.g. standby, muting, menu, EPG, etc. may be provided as well.

Each pair of buttons 302, 303, 304, and 305 includes two buttons which have a mutually opposite effect, for example, increasing and decreasing, respectively, a particular parameter such as audio volume or selected channel preset number. If any of these buttons is repeatedly pressed within a certain period of time, the sequence is compared will earlier received command sequences. Within such a sequence, consecutive pairs of opposite commands are ignored, because they do not contribute to the final effect of the sequence. If it appears that the received sequence matches an earlier sequence, a macrocommand is added which can be selected by the user by successively pressing the corresponding button and the confirmation button 306. At the same time, an opposite macrocommand is added which can be selected by successively pressing the corresponding opposite button and the confirmation button 306. For example, if the user presses the channel-up button 304a four times, and the same sequence is found to be received earlier, a macrocommand including four channel-up commands is generated which can be selected by successively pressing the channel-up button 304a and the confirmation button 306. Also, a macrocommand including four channel-down commands is generated which can be selected by successively pressing the channel-down button 304b and the confirmation button 306.

If the command sequence appears not to be received earlier, but the opposite sequence was found to be received earlier, the same macrocommands are generated and similarly assigned to buttons of the remote control unit 301. For example, if the user presses the channel-up button 304a four times, and a sequence including four channel-down commands appears to be received earlier, the same macrocommands are generated as described above, and similarly assigned to the buttons 304a and 304b, respectively.

If no matching or counter matching earlier sequence was found, the received command sequence itself is stored as a potential macrosequence, for comparison with future command sequences.

1. A system comprising
a user-controllable device;
a user interface arranged to receive user-selectable commands and to send control signals to the device for executing the commands, at least two of said user-selectable commands having an opposite effect;
a memory unit arranged to record a first sequence of received commands;
a matching unit for determining whether a second sequence of commands received subsequent to said first sequence matches or counter-matches said first sequence;
the system being arranged to add a further command and a further opposite command to the user interface in response to detection that said second sequence matches or counter-matches said first sequence, the further command and the further opposite command becoming user-selectable so that, in response to user selection of the further command, the user interface sends control signals for executing a series of commands corresponding to commands of the first sequence, and in response to user selection of the further opposite command, the user interface sends control signals for executing a series of commands corresponding in an opposite way to commands of the first sequence.

2. A system as claimed in claim 1, wherein the matching unit is capable of recognizing in the first sequence an iteration of a basic command, the system being arranged to determine an opposite basic command which has the opposite effect of said basic command, and to include an iteration of said opposite basic command in said further opposite command.

3. A system as claimed in claim 2, wherein user selection of the further command involves at least selection of said basic command and user selection of the further opposite command involves at least selection of said opposite basic command.

4. A system as claimed in claim 3, wherein the user selection of the further command and the further opposite command further involves a predetermined command preceding or following the basic command or the opposite basic command, respectively.

5. A system as claimed in claim 3, wherein the user selection of the further command and the further opposite command involves prolonged operation of a control element corresponding to the basic command or the opposite basic command, respectively.

6. A system as claimed in claim 3, wherein the further command and the further opposite command temporarily replace the basic command and the opposite basic command.

7. A remote control unit comprising
a user interface arranged to receive user-selectable commands and to send control signals to a user-controllable device for executing the commands, at least two of said user-selectable commands having an opposite effect;
a memory unit arranged to record a first sequence of received commands;
a matching unit for determining whether a second sequence of commands received subsequent to said first sequence matches or counter-matches said first sequence;
the remote control unit being arranged to add a further command and a further opposite command to the user interface in response to detection that said second sequence matches or counter- matches said first sequence, the further command and the further opposite command becoming user-selectable so that, in response to user selection of the further command, the user interface sends control signals for executing a series of commands corresponding to commands of the first sequence, and in response to user selection of the further opposite command, the user interface sends control signals for executing a series of commands corresponding in an opposite way to commands of the first sequence.

8. A user-controllable device comprising
a user interface arranged to receive user-selectable commands for executing the commands, at least two of said user- selectable commands having an opposite effect;
a memory unit arranged to record a first sequence of received commands;
a matching unit for determining whether a second sequence of commands received subsequent to said first sequence matches or counter-matches said first sequence;
the user-controllable device being arranged to add a further command and a further opposite command to the user interface in response to detection that said second sequence matches or counter-matches said first sequence, the further command and the further opposite command becoming user-selectable so that, in response to user selection of the further command, the user interface sends control signals for executing a series of commands corresponding to commands of the first sequence, and in response to user selection of the further opposite command, the user interface sends control signals for executing a series of commands corresponding in an opposite way to commands of the first sequence.

9. A computer program product enabling a programmable device when executing said computer program product to function as a system or device as defined in claim 1.
